(19) United States
(12) Patent Application Publication
(10) Pub. No.: US 2018/0048429 A1
(43) Pub. Date: Feb. 15, 2018

(54) TERMINAL DEVICE, BASE STATION DEVICE, INTEGRATED CIRCUIT, AND COMMUNICATION METHOD

(71) Applicant: Sharp Kabushiki Kaisha, Sakai City, Osaka (JP)

(72) Inventors: HIROKI TAKAHASHI, Sakai City (JP); SHOICHI SUZUKI, Sakai City (JP); TATSUSHI AIBA, Sakai City (JP); KAZUNARI YOKOMAKURA, Sakai City (JP)

(21) Appl. No.: 15/546,842

(22) PCT Filed: Jan. 28, 2016
(86) PCT No.: PCT/JP2016/052419

§ 371 Date: Oct. 25, 2017

(30) Foreign Application Priority Data
Jan. 29, 2015 (JP) 2015-014992

(51) Int. Cl. H04L 1/18; H04W 72/04

(52) U.S. Cl. CPC H04L 1/1812; H04L 1/1861; H04W 72/0413; H04J 3/00

(57) ABSTRACT

A terminal device communicating with a base station device transmits an HARQ-ACK with respect to PDSCH on a serving cell in a first cell group by using a PUCCH on a first serving cell in the first cell group, transmits an HARQ-ACK with respect to a PDSCH on a serving cell in a second cell group by using a PUCCH on a second serving cell in the second cell group, and transmits, to the base station device, information including first information indicating whether to support CA using UL-DL configuration combinations different between a serving cell in a first band and a serving cell in a second band in the first cell group, and second information indicating whether to support CA using UL-DL configuration combinations different between the serving cell in the first band and a serving cell in the second cell group.

### TECHNICAL FIELD

The present invention relates to a terminal device, a base station device, an integrated circuit, and a communication method.

This application claims priority based on Japanese Patent Application No. 2015-014992 filed on Jan. 29, 2015, the contents of which are incorporated herein by reference.

### BACKGROUND ART

In the 3rd Generation Partnership Project (3GPP), a radio access method and a radio network for cellular mobile communications (hereinafter, referred to as “Long Term Evolution (LTE),” or “Evolved Universal Terrestrial Radio Access (EUTRA)”) have been considered (NPL 1, NPL 2, NPL 3, NPL 4, and NPL 5). In LTE, a base station device is also referred to as an evolved NodeB (eNodeB), and a terminal device is also referred to as user equipment (UE). LTE is a cellular communication system in which an area is divided into multiple cells to form a cellular pattern, each of the cells being served by a base station device. A single base station device may manage multiple cells.

LTE supports a time division duplex (TDD). LTE that employs a TDD scheme is also referred to as TD-LTE or LTE TDD. In TDD, an uplink signal and a downlink signal are time-division multiplexed. LTE supports a frequency division duplex (FDD).

In 3GPP, carrier aggregation has been specified in which a terminal device can simultaneously perform transmission and/or reception on up to five serving cells (component carriers).

In 3GPP, a configuration where a terminal device simultaneously performs transmission and/or reception on more than five serving cells (component carriers) has been considered (NPL 1). Furthermore, a configuration where a terminal device performs transmission of a physical uplink control channel on a secondary cell that is a serving cell other than a primary cell has been considered (NPL 6).

### CITATION LIST

### Non-Patent Literature

NPL 1: “3GPP TS 36.211 V12.4.0 (2014-12) Evolved Universal Terrestrial Radio Access (E-UTRA); Physical channels and modulation (Release 12)”, 6 Jan. 2015.
NPL 2: “3GPP TS 36.212 V12.3.0 (2014-12) Evolved Universal Terrestrial Radio Access (E-UTRA); Multiplexing and channel coding (Release 12)”, 6 Jan. 2015.
NPL 3: “3GPP TS 36.213 V 12.4.0 (2014-12) Evolved Universal Terrestrial Radio Access (E-UTRA); Physical layer procedures (Release 12)”, 7 Jan. 2015.
NPL 4: “3GPP TS 36.321 V 12.4.0 (2014-12) Evolved Universal Terrestrial Radio Access (E-UTRA); Medium Access Control (MAC) protocol specification (Release 12)”, 5 Jan. 2015.
NPL 5: “3GPP TS 36.331 V12.4.1 (2014-12) Evolved Universal Terrestrial Radio Access (E-UTRA); Radio Resource Control (RRC); Protocol specification (Release 12)”, 7 Jan. 2015.
NPL 6: “New WI proposal: LTE Carrier Aggregation Enhancement Beyond5 Carriers”, RP-142286, Nokia Corporation, NTT DoCoMo Inc., Nokia Networks, 3GPP TSG RAN Meeting #66, Hawaii, United States of America, 8-11 Dec. 2014.

### DISCLOSURE OF THE INVENTION

### Problems to be Solved by the Invention

However, in such a radio communication system, a concrete method for processing in transmitting uplink control information has not been sufficiently studied.

Some aspects of the present invention have been made in light of the foregoing, and an object of the invention is to provide a terminal device, a base station device, an integrated circuit, and a communication method that enable efficient communication using multiple cells (component carriers).

### Means for Solving the Problems

(1) In order to accomplish the above-described object, some aspects of the present invention are contrived to provide the following means. Specifically, a terminal device according to an aspect of the present invention is a terminal device communicating with a base station device, and the terminal device may include a transmission unit configured to: transmit an HARQ-ACK with respect to a physical downlink shared channel on multiple serving cells included in a first cell group to the base station device by using a physical uplink control channel on a first serving cell included in the first cell group; transmit an HARQ-ACK with respect to a physical downlink shared channel on multiple serving cells included in a second cell group to the base station device by using a physical uplink control channel on a second serving cell included in the second cell group; and transmit, to the base station device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

(2) A base station device according to an aspect of the present invention is a base station device communicating with a terminal device, and the base station device may include a reception unit configured to: receive an HARQ-ACK with respect to a physical downlink shared channel on multiple serving cells included in a first cell group from the terminal device by using a physical uplink control channel on a first serving cell included in the first cell group; receive an HARQ-ACK with respect to a physical downlink shared channel on multiple serving cells included in a second cell group from the terminal device by using a physical uplink control channel on a second serving cell included in the second cell group; and receive, from the terminal device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

(3) An integrated circuit according to an aspect of the present invention is an integrated circuit mounted on a terminal device communicating with a base station device, and the integrated circuit may cause the terminal device to exert a series of functions of: transmitting an HARQ-ACK with respect to a physical downlink shared channel on multiple serving cells included in a first cell group to the base station device by using a physical uplink control channel on a first serving cell included in the first cell group; transmitting an HARQ-ACK with respect to a physical downlink shared channel on multiple serving cells included in a second cell group to the base station device by using a physical uplink control channel on a second serving cell included in the second cell group; and transmitting, to the base station device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

(4) An integrated circuit according to an aspect of the present invention is an integrated circuit mounted on a base station device communicating with a terminal device, and the integrated circuit may cause the base station device to exert a series of functions of: receiving an HARQ-ACK with respect to a physical downlink shared channel on multiple serving cells included in a first cell group from the terminal device by using a physical uplink control channel on a first serving cell included in the first cell group; receiving an HARQ-ACK with respect to a physical downlink shared channel on multiple serving cells included in a second cell group from the terminal device by using a physical uplink control channel on a second serving cell included in the second cell group; and receiving, from the terminal device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

(5) A communication method according to an aspect of the present invention is a communication method used by a terminal device communicating with a base station device, and the method may include the steps of: transmitting an HARQ-ACK with respect to a physical downlink shared channel on multiple serving cells included in a first cell group to the base station device by using a physical uplink control channel on a first serving cell included in the first cell group; transmitting an HARQ-ACK with respect to a physical downlink shared channel on multiple serving cells included in a second cell group to the base station device by using a physical uplink control channel on a second serving cell included in the second cell group; and transmitting, to the base station device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

(6) A communication method according to an aspect of the present invention is a communication method used by a base station device communicating with a terminal device, and the method may include the steps of: receiving an HARQ-ACK with respect to a physical downlink shared channel on multiple serving cells included in a first cell group from the terminal device by using a physical uplink control channel on a first serving cell included in the first cell group; receiving an HARQ-ACK with respect to a physical downlink shared channel on multiple serving cells included in a second cell group from the terminal device by using a physical uplink control channel on a second serving cell included in the second cell group; and receiving, from the terminal device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

### Effects of the Invention

According to some aspects of the invention, the uplink control information can be efficiently transmitted.

### BRIEF DESCRIPTION OF THE DRAWINGS

FIG. 1 is a conceptual diagram of a radio communication system according to the present embodiment.

FIG. 2 is a diagram illustrating a schematic configuration of a radio frame according to the present embodiment.

FIG. 3 is a diagram illustrating a configuration of a slot according to the present embodiment.

FIG. 4 is a diagram illustrating one example of allocation of a physical channel and mapping of a physical signal to a downlink subframe according to the present embodiment.

FIG. 5 is a diagram illustrating one example of allocation of a physical channel and mapping of a physical signal to an uplink subframe according to the present embodiment.

FIG. 6 is a diagram illustrating one example of allocation of a physical channel and mapping of a physical signal to a special subframe according to the present embodiment.

FIGS. 7A to 7C are diagrams illustrating a PUCCH cell group according to the present embodiment.

FIG. 8 is a diagram illustrating one example of a UL-DL configuration according to the present embodiment.

FIG. 9 is a schematic block diagram illustrating a configuration of a terminal device 1 according to the present embodiment.

FIG. 10 is a schematic block diagram illustrating a configuration of a base station device 3 according to the present embodiment.

FIG. 11 is a sequence chart relating to transmission of UECapabilityInformation according to the present embodiment.

FIG. 12 is a diagram illustrating information/parameters included in UECapabilityInformation according to the present embodiment.

FIG. 13 is a diagram illustrating information/parameters included in SupportedBandCombination according to the present embodiment.

FIG. 14 is a diagram illustrating information/parameters included in BandParameters according to the present embodiment.

FIG. 15 is a diagram illustrating one example of RF-Parameters according to the present embodiment.

### MODE FOR CARRYING OUT THE INVENTION

Embodiments of the present invention will be described below.

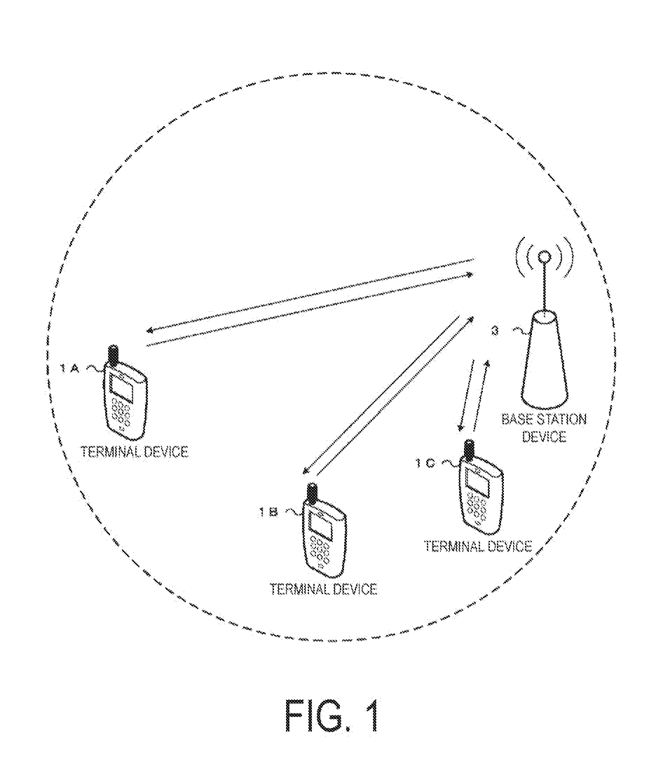

FIG. 1 is a conceptual diagram of a radio communication system according to the present embodiment. In FIG. 1, the radio communication system includes terminal devices 1A to IC and a base station device 3. Hereinafter, the terminal devices 1A to IC are each referred to as a terminal device 1.

Physical channels and physical signals according to the present embodiment will be described.

In FIG. 1, in uplink radio communication from the terminal device 1 to the base station device 3, the following uplink physical channels are used. The uplink physical channel is used to transmit information output from a higher layer.
Physical uplink control channel (PUCCH)
Physical uplink shared channel (PUSCH)
Physical random access channel (PRACH)

The PUCCH is used to transmit uplink control information (UCI). Here, the uplink control information may include channel state information (CSI) used to indicate a state of a downlink channel. The uplink control information may include a scheduling request (SR) used to request a UL-SCH resource. The uplink control information may include a hybrid automatic repeat request acknowledgement (HARQ-ACK). The HARQ-ACK indicates an HARQ-ACK with respect to downlink data (transport block, medium access control protocol data unit: MAC PDU, downlink-shared channel: DL-SCH, physical downlink shared channel: PDSCH).

In other words, the HARQ-ACK indicates an acknowledgement (ACK) or a negative-acknowledgement (NACK). Here, the HARQ-ACK is also referred to as an ACK/NACK, HARQ feedback, HARQ response, HARQ information, or HARQ control information.

The PUSCH is used to transmit uplink data (uplink-shared channel (UL-SCH)). Furthermore, the PUSCH may be used to transmit the HARQ-ACK and/or channel state information along with the uplink data. Furthermore, the PUSCH may be used to transmit only the channel state information or to transmit only the HARQ-ACK and the channel state information. In other words, the PUSCH may be used to transmit only the uplink control information.

Here, the base station device 3 and the terminal device 1 communicate a signal in (transmit and receive a signal to and from) the higher layer. For example, the base station device 3 and the terminal device 1 may transmit and receive radio resource control (RRC) signaling (also referred to as a RRC message, RRC information) in a RRC layer. The base station device 3 and the terminal device 1 may transmit and receive a medium access control (MAC) control element in a MAC layer. Here, the RRC signaling and/or MAC control element is also referred to as higher layer signaling.

The PUSCH is used to transmit the RRC signaling and the MAC control element. Here, the RRC signaling transmitted from the base station device 3 may be signaling shared by multiple terminal devices 1 on a cell. The RRC signaling transmitted from the base station device 3 may be signaling dedicated to a certain terminal device 1 (also referred to as dedicated signaling). In other words, user device-specific (user device-unique) information is transmitted using the signaling dedicated to a certain terminal device 1.

The PRACH is used to transmit a random access preamble. The PRACH is used for the initial connection establishment procedure, the handover procedure, the connection re-establishment procedure, synchronization (timing adjustment) for uplink transmission, and the request for the PUSCH resource.

In FIG. 1, the following uplink physical signal is used in the uplink radio communication. The uplink physical signal is not used to transmit information output from the higher layer, but is used by a physical layer.
Uplink reference signal (UL RS)

According to the present embodiment, the following two types of uplink reference signals are used.
Demodulation reference signal (DMRS)
Sounding reference signal (SRS)

The DMRS is associated with transmission of the PUSCH or the PUCCH. The DMRS is time-multiplexed with the PUSCH or the PUCCH. The base station device 3 uses the DMRS in order to perform channel compensation of the PUSCH or the PUCCH. Transmission of both the PUSCH and the DMRS is hereinafter referred to simply as transmission of the PUSCH. Transmission of both the PUCCH and the DMRS is hereinafter referred to simply as transmission of the PUCCH.

The SRS has no association with the transmission of the PUSCH or the PUCCH. The base station device 3 uses the SRS in order to measure an uplink channel state.

In FIG. 1, the following downlink physical channels are used for downlink radio communication from the base station device 3 to the terminal device 1. The downlink physical channels are used to transmit the information output from the higher layer.
Physical broadcast channel (PBCH)
Physical control format indicator channel (PCFICH)
Physical hybrid automatic repeat request indicator channel (PHICH)
Physical downlink control channel (PDCCH)
Enhanced physical downlink control channel (EPDCCH)
Physical downlink shared channel (PDSCH)
Physical multicast channel (PMCH)

The PBCH is used to broadcast a master information block (MIB), or a broadcast channel (BCH), that is shared by the terminal devices 1.

The PCFICH is used to transmit information indicating a region (OFDM symbols) to be used for transmission of the PDCCH.

The PHICH is used to transmit an HARQ indicator (HARQ feedback or response information) indicating an acknowledgement (ACK) or a negative acknowledgement (NACK) with respect to the uplink data (uplink shared channel (UL-SCH)) received by the base station device 3.

The PDCCH and the EPDCCH are used to transmit downlink control information (DCI).

The PDSCH is used to transmit downlink data (downlink shared channel (DL-SCH)). The PDSCH is used to transmit a system information message. The system information message may be cell-specific (cell-unique) information. Here, the system information is included in the RRC signaling. The PDSCH is used to transmit the RRC signaling and the MAC control element.

The PMCH is used to transmit multicast data (multicast channel (MCH)).

In FIG. 1, in the downlink radio communication, the following downlink physical signals are used. The downlink physical signals are not used to transmit the information output from the higher layer, but are used by the physical layer.
Synchronization signal (SS)
Downlink reference signal (DL RS)

The synchronization signal is used in order for the terminal device 1 to be synchronized in terms of frequency and time domains for downlink. In the TDD scheme, the synchronization signal is mapped to subframes 0, 1, 5, and 6 within a radio frame. In the FDD scheme, the synchronization signal is mapped to subframes 0 and 5 within the radio frame.

The downlink reference signal is used in order for the terminal device 1 to perform the channel compensation of the downlink physical channel. The downlink reference signal is used in order for the terminal device 1 to calculate the downlink channel state information.

According to the present embodiment, the following five types of downlink reference signals are used.
Cell-specific reference signal (CRS)
UE-specific reference signal (URS) associated with the PDSCH
Demodulation reference signal (DMRS) associated with the EPDCCH
Non-zero power channel state information-reference signal (NZP CSI-RS)
Zero power channel state information-reference signal (ZP CSI-RS)
Multimedia broadcast and multicast service over single frequency network reference signal (MBSFN RS)
Positioning reference signal (PRS)

The downlink physical channel and the downlink physical signal are collectively referred to as a downlink signal. The uplink physical channel and the uplink physical signal are collectively referred to as an uplink signal. The downlink physical channel and the uplink physical channel are collectively referred to as a physical channel. The downlink physical signal and the uplink physical signal are collectively referred to as a physical signal.

The BCH, the MCH, the UL-SCH, and the DL-SCH are transport channels. A channel used in the medium access control (MAC) layer is referred to as a transport channel. The unit of the transport channel used in the MAC layer is referred to as a transport block (TB) or a MAC protocol data unit (PDU). Control of a hybrid automatic repeat request (HARQ) is performed for each transport block in the MAC layer. The transport block is a unit of data that the MAC layer delivers to the physical layer. In the physical layer, the transport block is mapped to a codeword, and coding processing is performed on a codeword-by-codeword basis.

The carrier aggregation will be described below.

In FIG. 1, one or multiple serving cells may be configured for the terminal device 1. A technology in which the terminal device 1 communicates via multiple serving cells is referred to as cell aggregation or carrier aggregation. The present invention may be applied to one serving cell or each of multiple serving cells configured for terminal device 1. Furthermore, the present invention may be applied to one serving cell or some of multiple serving cells configured for terminal device 1. As described below, the present invention may be applied to one group of serving cells or each of multiple groups of serving cells configured for terminal device 1. Furthermore, the present invention may be applied to one group of serving cells or some of multiple groups of serving cells configured for terminal device 1.

Time division duplex (TDD) and/or frequency division duplex (FDD) may be applied to the radio communication system illustrated in FIG. 1. For carrier aggregation, the TDD or the FDD may be applied to one serving cell or all of multiple serving cells. For carrier aggregation, serving cells to which the TDD is applied and serving cells to which the FDD is applied may be aggregated. Here, a frame structure corresponding to the FDD is also referred to as a frame structure type 1. A frame structure corresponding to the TDD is also referred to as a frame structure type 2.

Here, the configured one or multiple serving cells include one primary cell and one or multiple secondary cells. The primary cell may be a serving cell on which an initial connection establishment procedure has been performed, a serving cell in which a connection re-establishment procedure has been started, or a cell indicated as a primary cell during a handover procedure. At a point of time when an RRC connection is established, or later, a secondary cell may be configured.

Here, a carrier corresponding to a serving cell in the downlink is referred to as a downlink component carrier. A carrier corresponding to a serving cell in the uplink is referred to as an uplink component carrier. The downlink component carrier and the uplink component carrier are collectively referred to as a component carrier.

The terminal device 1 can simultaneously perform transmission and/or reception of multiple physical channels on one or multiple serving cells (component carriers). Here, one physical channel is transmitted on one serving cell (component carrier) of multiple serving cells (component carriers).

Here, the primary cell is used to transmit the PUCCH. The primary cell cannot be deactivated. Cross-carrier scheduling does not apply to primary cell. In other words, the primary cell is always scheduled via its PDCCH. In a case that (monitoring) PDCCH of a certain secondary cell is configured, cross-carries scheduling may not apply this secondary cell. In other words, in this case, the secondary cell may be always scheduled via its PDCCH. In a case that (monitoring) PDCCH of a certain secondary cell is not configured, the cross-carrier scheduling may apply such that the secondary cell is always scheduled via the PDCCH of one other serving cell.

Here, in the present embodiment, a secondary cell used to transmit the PUCCH is referred to as a PUCCH secondary cell or a special secondary cell. In the present embodiment, a secondary cell not used to transmit the PUCCH is referred to as a non-PUCCH secondary cell, a non-special secondary cell, a non-PUCCH serving cell, or a non-PUCCH cell. The primary cell and the PUCCH secondary cell are collectively referred to as a PUCCH serving cell or a PUCCH cell.

Here, the PUCCH serving cell (primary cell, PUCCH secondary cell) always has the downlink component carrier and the uplink component carrier. A PUCCH resource is configured in the PUCCH serving cell (primary cell, PUCCH secondary cell).

The non-PUCCH serving cell (non-PUCCH secondary cell) may have only the downlink component carrier. The non-PUCCH serving cell (non-PUCCH secondary cell) may have the downlink component carrier and the uplink component carrier.

The terminal device 1 performs PUCCH transmission on the PUCCH serving cell. In other words, the terminal device 1 performs PUCCH transmission on the primary cell. Moreover, the terminal device 1 performs PUCCH transmission on the PUCCH secondary cell. The terminal device 1 does not perform PUCCH transmission on the non-special secondary cell.

Here, the PUCCH secondary cell may be defined as a serving cell that is neither a primary cell nor a secondary cell.

In other words, the PUCCH secondary cell is used to transmit the PUCCH. The PUCCH secondary cell may not be deactivated. Here, the PUCCH secondary cell may be activated and/or deactivated as described later.

The cross-carrier scheduling may not apply to PUCCH secondary cell. In other words, the PUCCH secondary cell is always scheduled via its PDCCH. Here, the cross-carrier scheduling may apply to PUCCH secondary cell. In other words, the PUCCH secondary cell may be scheduled via the PDCCH of one other serving cell.

For example, in a case that (monitoring) PDCCH of a PUCCH secondary cell is configured, cross-carries scheduling may not apply this PUCCH secondary cell. In other words, in this case, the PUCCH secondary cell may be always scheduled via its PDCCH. In a case that (monitoring) PDCCH of the PUCCH secondary cell is not configured, the cross-carrier scheduling may apply such that the PUCCH secondary cell is always scheduled via the PDCCH of one other serving cell.

Here, linking may be defined between the uplink (e.g., uplink component carrier) and the downlink (e.g., the downlink component carrier). In other words, in accordance with the linking between the uplink and the downlink, the serving cell for downlink assignment (serving cell on which PDSCH transmission scheduled via downlink assignment (downlink transmission) is performed) may be identified. In accordance with the linking between the uplink and the downlink, the serving cell for uplink grant (serving cell on which PUSCH transmission scheduled via uplink grant (uplink transmission) is performed) may be identified. Here, there is no carrier indicator field in the downlink assignment or the uplink.

In other words, the downlink assignment received on the primary cell corresponds to the downlink transmission on the primary cell. The uplink grant received on the primary cell corresponds to the uplink transmission on the primary cell. The downlink assignment received on the PUCCH secondary cell may correspond to the downlink transmission on the PUCCH secondary cell. The uplink grant received on the PUCCH secondary cell may correspond to the uplink transmission on the PUCCH secondary cell. The downlink assignment received on a certain secondary cell (PUCCH secondary cell and/or non-PUCCH secondary cell) may correspond to the downlink transmission on this secondary cell. The uplink grant received on a certain secondary cell (PUCCH secondary cell and/or non-PUCCH secondary cell) may correspond to the uplink transmission on the certain secondary cell.

A configuration of the radio frame according to the present embodiment will be described below.

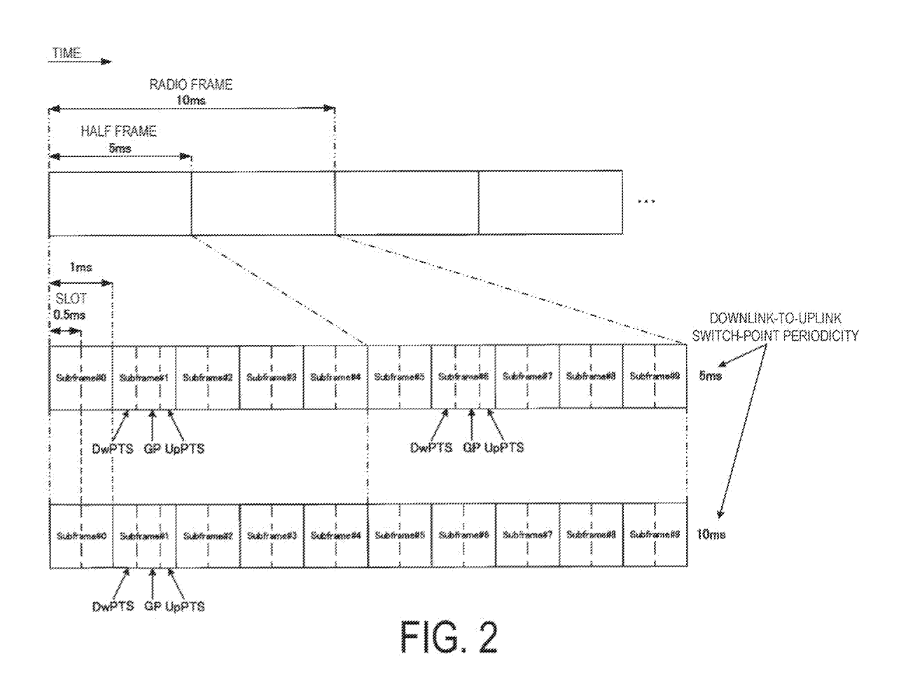

FIG. 2 is a diagram illustrating a schematic configuration of the radio frame according to the present embodiment. Each of the radio frames is 10 ms in length. In FIG. 2, the horizontal axis is a time axis. Furthermore, each of the radio frames is constituted of two half frames. Each of the half frames is 5 ms in length. Each of the half frames is constituted of five subframes. Each of the subframes is 1 ms in length and is defined by two consecutive slots. Each of the slots is 0.5 ms in length. The i-th subframe within a radio frame is constituted of the (2×i)-th slot and the (2×i+1)-th slot. To be more precise, 10 subframes can be used at each interval of 10 ms.

According to the present embodiment, the following three types of subframes are defined.
Downlink subframe (a first subframe)
Uplink subframe (a second subframe)
Special subframe (a third subframe)

The downlink subframe is a subframe reserved for the downlink transmission. The uplink subframe is a subframe reserved for the uplink transmission. The special subframe is constituted of three fields. The three fields are a downlink pilot time slot (DwPTS), a guard period (GP), and an uplink pilot time slot (UpPTS). The sum of lengths of the DwPTS, the GP, and the UpPTS in one special subframe is 1 ms. The DwPTS is a field reserved for the downlink transmission. The UpPTS is a field reserved for the uplink transmission. The GP is a field in which neither the downlink transmission nor the uplink transmission is performed. Moreover, the special subframe may be constituted of only the DwPTS and the GP, or may be constituted of only the GP and the UpPTS.

A single radio frame is constituted of at least the downlink subframe, the uplink subframe, and the special subframe.

A configuration of a slot according to the present embodiment will be described below.

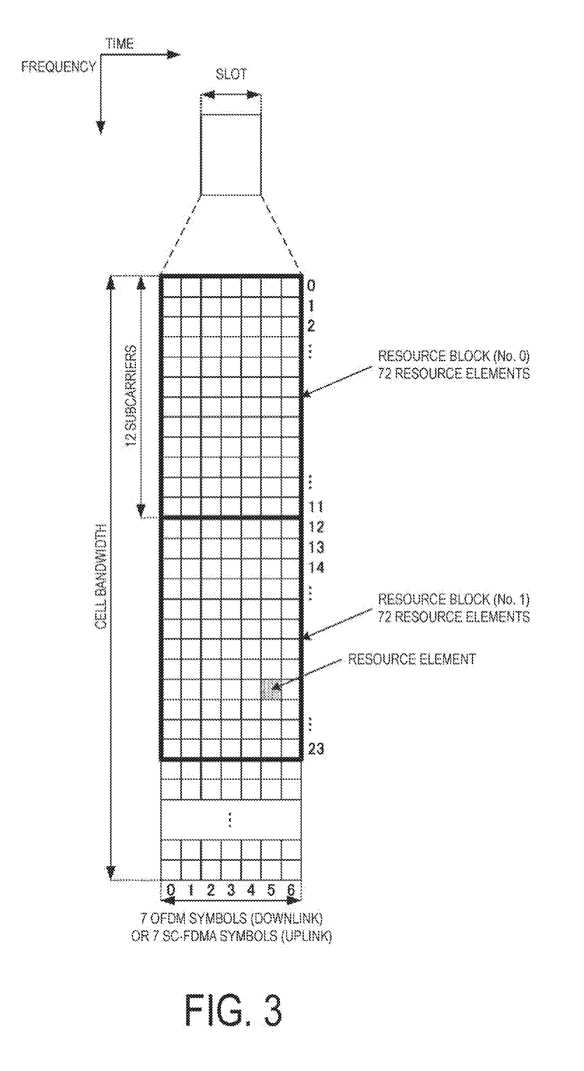

FIG. 3 is a diagram illustrating a configuration of a slot according to the present embodiment. According to the present embodiment, a normal cyclic prefix (CP) may be applied to the OFDM symbol. Moreover, an extended cyclic prefix (CP) may be applied to the OFDM symbol. The physical signal or the physical channel transmitted in each of the slots is expressed by a resource grid. In FIG. 3, the horizontal axis is a time axis, and the vertical axis is a frequency axis.

In downlink, the resource grid may be defined by multiple subcarriers and multiple OFDM symbols. In uplink, the resource grid may be defined by multiple subcarriers and multiple SC-FDMA symbols. The number of subcarriers constituting one slot may depend on a cell bandwidth. The number of OFDM symbols or SC-FDMA symbols constituting one slot may be seven. Each element within the resource grid is referred to as a resource element. The resource element may be identified by a subcarrier number, and an OFDM symbol or SC-FDMA symbol number.

A resource block may be used to express mapping of a certain physical channel (the PDSCH, the PUSCH, or the like) to the resource elements. The resource block may be defined by a virtual resource block and a physical resource block. A certain physical channel may be first mapped to the virtual resource block. Thereafter, the virtual resource block is mapped to the physical resource block. One physical resource block may be defined by seven consecutive OFDM symbols or SC-FDMA symbols in a time domain and by 12 consecutive subcarriers in a frequency domain. Therefore, one physical resource block may be is constituted of (7×12) resource elements. Furthermore, one physical resource block may correspond to one slot in the time domain and correspond to 180 kHz in the frequency domain. The physical resource blocks may be numbered from 0 in the frequency domain.

The physical channel and the physical signal that are transmitted in each of the subframes will be described below.

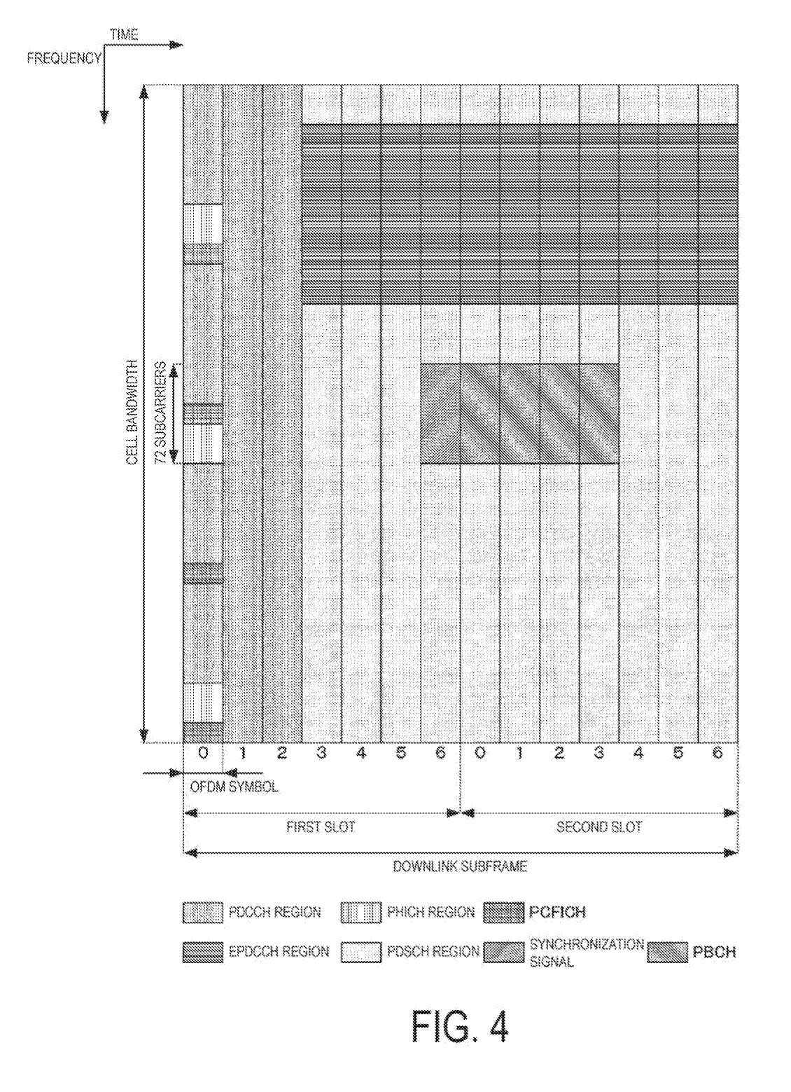

FIG. 4 is a diagram illustrating one example of allocation of a physical channel and mapping of a physical signal to a downlink subframe according to the present embodiment. In FIG. 4, the horizontal axis is a time axis, and the vertical axis is a frequency axis. In the downlink subframe, the base station device 3 may transmit the downlink physical channel (the PBCH, the PCFICH, the PHICH, the PDCCH, the EPDCCH, or the PDSCH), and the downlink physical signal (the synchronization signal or the downlink reference signal). Moreover, the PBCH is transmitted only in a subframe 0 within the radio frame. Moreover, the downlink reference signal is mapped to the resource elements distributed in the frequency domain and the time domain. The downlink reference signal is not illustrated in FIG. 4 for the sake of simplicity.

Multiple PDCCHs may be frequency-multiplexed and time-multiplexed in a PDCCH region. Multiple EPDCCHs may be frequency-multiplexed, time-multiplexed, and spatial-multiplexed in an EPDCCH region. Multiple PDSCHs may be frequency-multiplexed and spatial-multiplexed in a PDSCH region. The PDCCH and, the PDSCH or the EPDCCH may be time-multiplexed. The PDSCH and the EPDCCH may be frequency-multiplexed.

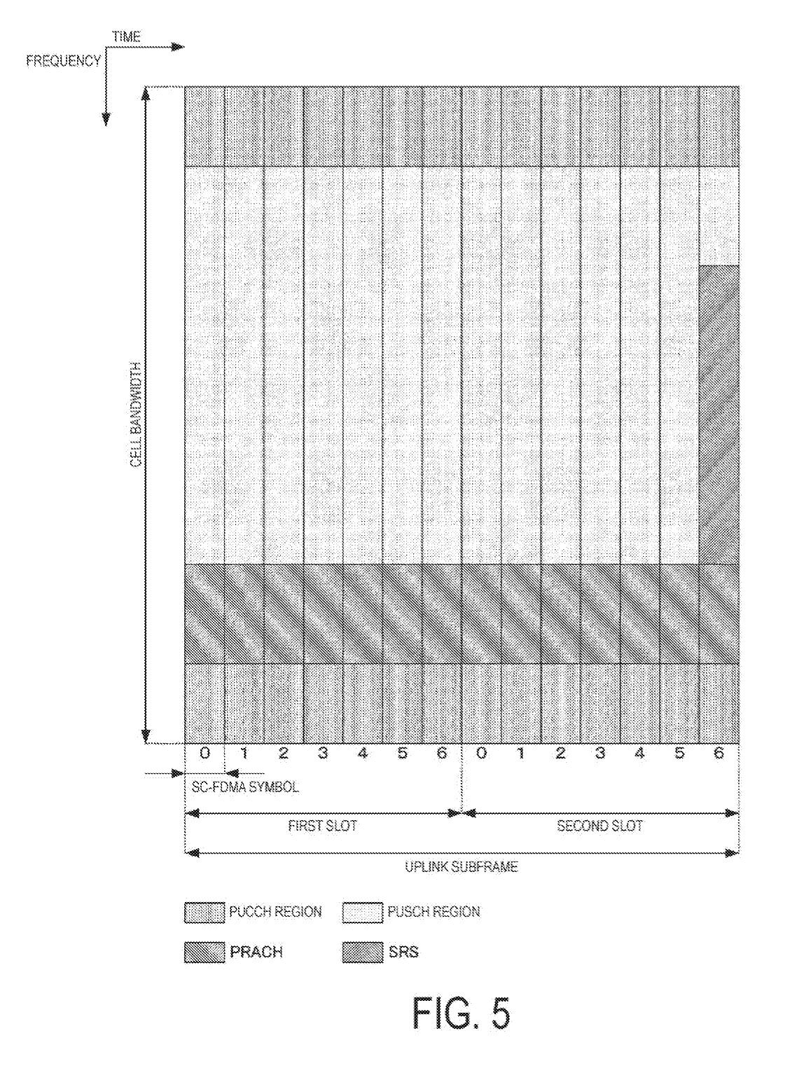

FIG. 5 is a diagram illustrating one example of allocation of the physical channel and mapping of the physical signal to the uplink subframe according to the present embodiment. In FIG. 5, the horizontal axis is a time axis, and the vertical axis is a frequency axis. In the uplink subframe, the terminal device 1 may transmit the uplink physical channel (the PUCCH, the PUSCH or the PRACH) and the uplink physical signal (the DMRS or the SRS). In a PUCCH region, multiple PUCCHs are frequency-multiplexed, time-multiplexed, and code-multiplexed. Multiple PUSCHs may be frequency-multiplexed and spatial-multiplexed in a PUSCH region. The PUCCH and the PUSCH may be frequency-multiplexed. The PRACH may be allocated over a single subframe or two subframes. Furthermore, multiple PRACHs may be code-multiplexed.

The SRS is transmitted using the last SC-FDMA symbol within the uplink subframe. To be more precise, the SRS is mapped to the last SC-FDMA symbol within the uplink subframe. The terminal device 1 cannot transmit the SRS and the PUCCH/PUSCH/PRACH simultaneously in a single SC-FDMA symbol on a single cell. In a single uplink subframe on a single cell, the terminal device 1 can transmit the PUSCH and/or the PUCCH using SC-FDMA symbols except for the last SC-FDMA symbol within the uplink subframe, and can transmit the SRS using the last SC-FDMA symbol within the uplink subframe. To be more precise, in the single uplink subframe on the single cell, the terminal device 1 can transmit both the SRS and the PUSCH/PUCCH at the same time. Moreover, the DMRS is time-multiplexed with the PUCCH or the PUSCH. The DMRS is not illustrated in FIG. 5 for the sake of simplicity.

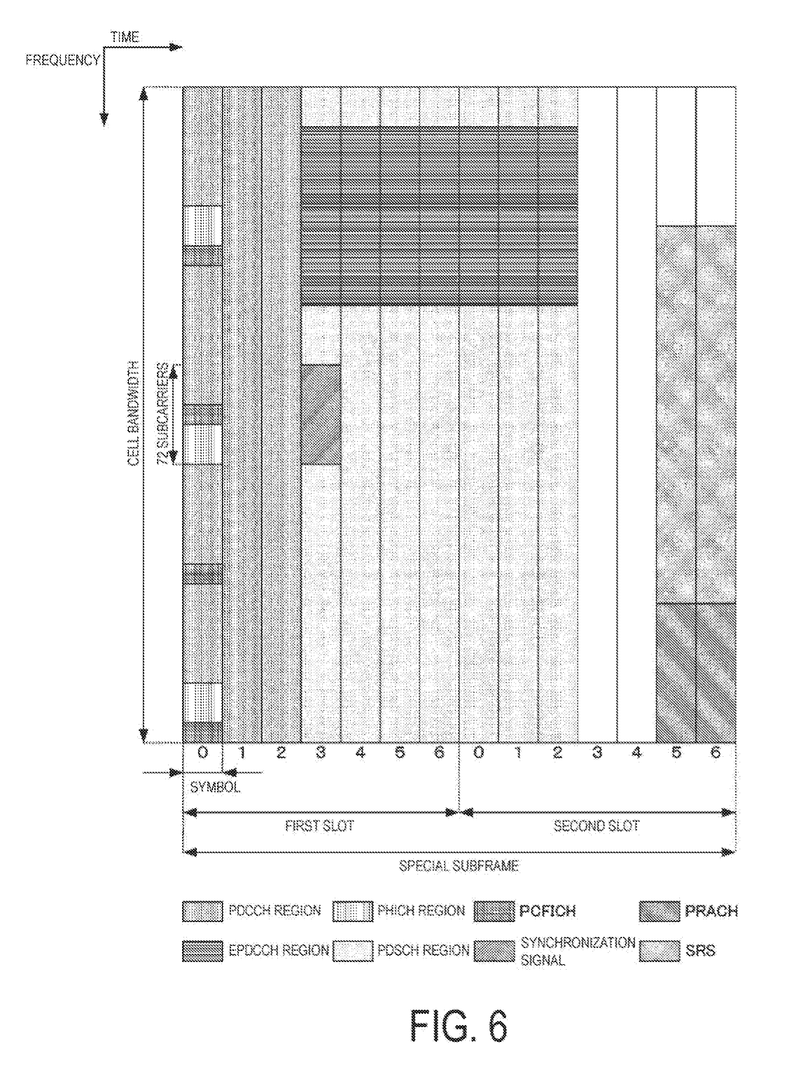

FIG. 6 is a diagram illustrating one example of allocation of the physical channel and mapping of the physical signal to the special subframe according to the present embodiment. In FIG. 6, the horizontal axis is a time axis, and the vertical axis is a frequency axis. In FIG. 6, the DwPTS is constituted of first to 10-th SC-FDMA symbols within the special subframe, the GP is constituted of 11-th and 12-th SC-FDMA symbols within the special subframe, and the UpPTS is constituted of 13-th and 14-th SC-FDMA symbols within the special subframe.

The base station device 3 may transmit the PCFICH, the PHICH, the PDCCH, the EPDCCH, the PDSCH, the synchronization signal, and the downlink reference signal, in the DwPTS of the special subframe. The base station device 3 does not transmit the PBCH in the DwPTS of the special subframe. The terminal device 1 may transmit the PRACH and the SRS in the UpPTS of the special subframe. To be more precise, the terminal device 1 transmits none of the PUCCH, the PUSCH, and the DMRS in the UpPTS of the special subframe.

In the present embodiment, a groups of multiple serving cells is referred to as a PUCCH cell group. A serving cell belongs to any one of the PUCCH cell groups.

One PUCCH cell group includes one PUCCH serving cell. One PUCCH cell group may include only one PUCCH serving cell. One PUCCH cell group may include one PUCCH serving cell, and one or multiple non-PUCCH serving cells.

A PUCCH cell group including the primary cell is referred to as a primary PUCCH cell group. A PUCCH cell group not including the primary cell is referred to as a secondary PUCCH cell group. In other words, the secondary PUCCH cell group includes the PUCCH secondary cell. For example, an index for the primary PUCCH cell group may be always set to 0. An index for the secondary PUCCH cell group may be configured by the base station device 3 (or a network device).

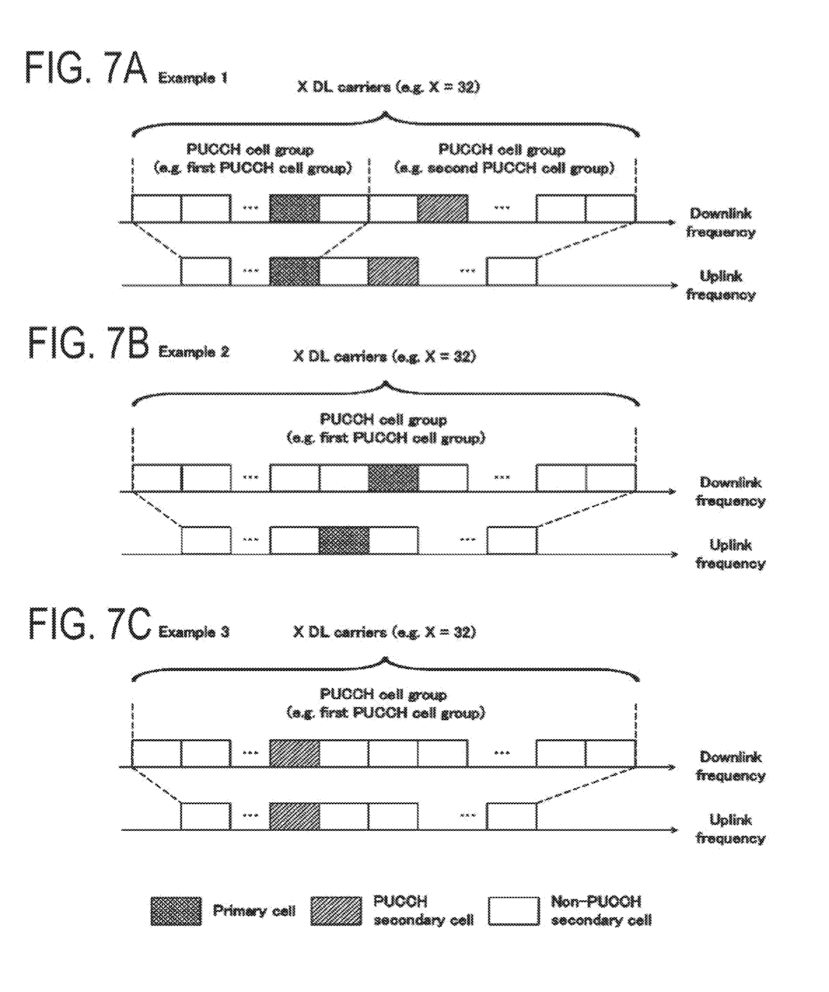

FIGS. 7A to 7C are diagrams illustrating the PUCCH cell group according to the present embodiment.

In the present embodiment, as illustrated in the FIGS. 7A to 7C, the carrier aggregation of up to 32 downlink component carrier (downlink cells) may be supported, for example. In other words, the base station device 3 and the terminal device 1 can simultaneously perform transmission and/or reception of multiple physical channels on up to 32 serving cells. Here, the number of the uplink component carriers may be less than the number of the downlink component carriers.

For example, the base station device 3 may configure a cell group associated with the PUCCH transmission (hereinafter, also referred to as a PUCCH cell group). For example, the PUCCH cell group may be associated with the PUCCH transmission of the uplink control information. FIG. 3A to 3C respectively illustrate three examples (Example (a), Example (b), and Example (c)) as examples of a configuration of the PUCCH cell group (constitution, definition). Here, it is needless to say that the PUCCH cell group may be configured differently from the examples illustrated in FIGS. 7A to 7C.

For example, the base station device 3 may transmit the higher layer signaling that includes information used to configure the PUCCH cell group. For example, an index used to identify the PUCCH cell group (cell group index, information) may be configured (defined) such that the base station device 3 transmit the higher layer signaling that includes the index used to identify the PUCCH cell group.

FIG. 7A illustrates that a first PUCCH cell group and a second PUCCH cell group are configured as PUCCH cell groups. For example, in FIG. 7A, the base station device 3 may transmit the downlink signal on the first PUCCH cell group, and the terminal device 3 may transmit the uplink signal on the first PUCCH cell group (or may transmit the uplink control information on the PUCCH on the first PUCCH cell group). For example, in a case that 20 serving cells (or the downlink component carriers or downlink cells) are configured or activated in the first PUCCH cell group, the uplink control information with respect to relevant 20 downlink component carriers may be transmitted.

In other words, the terminal device 1 may transmit the HARQ-ACK corresponding to 20 downlink component carriers (the HARQ-ACK with respect to PDSCH transmission, or the HARQ-ACK with respect to a transport block), for example. The terminal device 1 may transmit the CSI corresponding to 20 downlink component carriers. Moreover, the terminal device 1 may transmit the SR for each PUCCH cell group. Similarly, the terminal device 1 may transmit the uplink control information on the second PUCCH cell group.

In the same manner, the base station device 3 and terminal device 1 may also configure the PUCCH cell group as illustrated in FIG. 7B and transmit and receive the uplink control information on the PUCCH cell group. Further, the base station device 3 and terminal device 1 may configure the PUCCH cell group as illustrated in FIG. 7C and transmit and receive the uplink control information on the PUCCH cell group.

The base station device 3 may transmit information used to indicate the PUCCH secondary cell with the information included in the higher layer signaling and/or the PDCCH (the downlink control information transmitted on the PDCCH). The terminal device 1 may determine the PUCCH secondary cell in accordance with the information used to indicate the PUCCH secondary cell.

As described above, the PUCCH on the PUCCH serving cell may be used to transmit the uplink control information (HARQ-ACK, CSI (e.g., periodic CSI) and/or SR) with respect to a serving cell (PUCCH serving cell, non-PUCCH serving cell) included in the PUCCH cell group to which that PUCCH serving cell belongs.

In other words, the uplink control information (HARQ-ACK and/or CSI) with respect to a serving cell (PUCCH serving cell, non-PUCCH serving cell) included in the PUCCH cell group is transmitted using the PUCCH on the PUCCH serving cell included in the PUCCH cell group.

The present embodiment may be applied to only the HARQ-ACK. The present embodiment may be applied to only the CSI. The present embodiment may be applied to the HARQ-ACK and the CSI. The PUCCH cell group with respect to the HARQ-ACK and the PUCCH cell group with respect to the CSI may be individually defined. The PUCCH cell group with respect to the HARQ-ACK and the PUCCH cell group with respect to the CSI may be in common.

An uplink-downlink configuration (UL-DL configuration) according to the present embodiment will be described.

The UL-DL configuration is a configuration relating to a pattern of subframes within the radio frame. The UL-DL configuration indicates that each of the subframes within the radio frame corresponds to any one of the downlink subframe, the uplink subframe, and the special subframe, and is preferably expressed by any combinations of D, U, and S (which denote the downlink subframe, the uplink subframe, and the special subframe, respectively) in the length of 10 subframes. More preferably, the first subframe (to be more precise, subframe #0) is D, and the second subframe (to be more precise, subframe #1) is S.

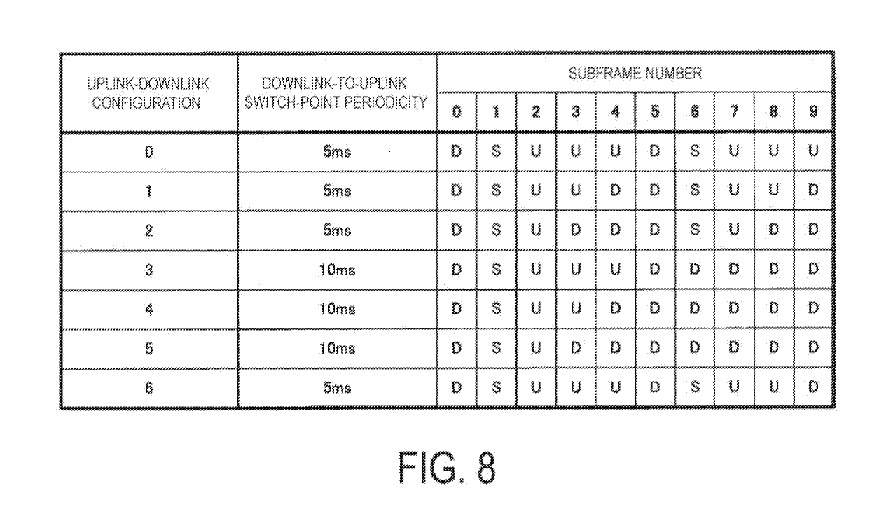

FIG. 8 is a table illustrating one example of the UL-DL configuration according to the present embodiment. In FIG. 8, D denotes a downlink subframe, U denotes an uplink subframe, and S denotes a special subframe.

A configuration of devices according to the present embodiment will be described below.

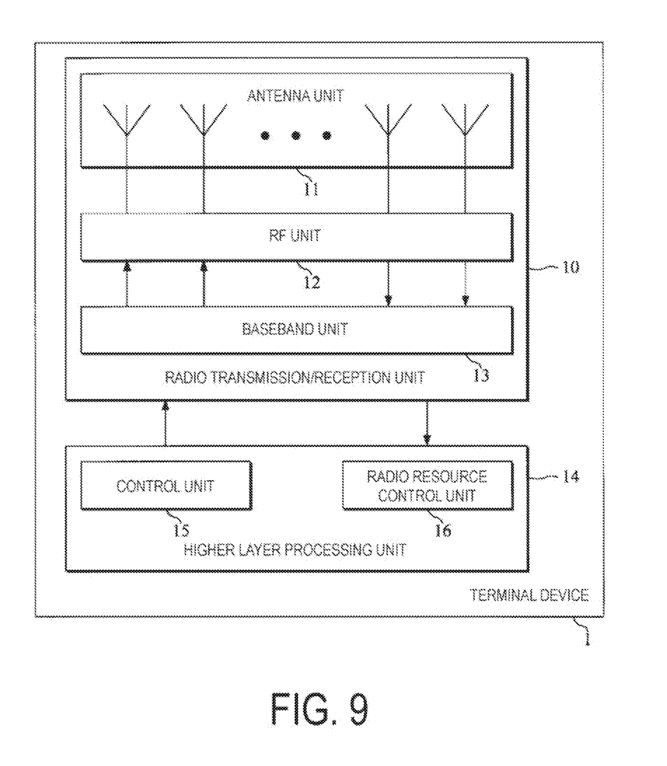

FIG. 9 is a schematic block diagram illustrating a configuration of the terminal device 1 according to the present embodiment. As illustrated in FIG. 9, the terminal device 1 is configured to include a radio transmission/reception unit 10 and a higher layer processing unit 14. The radio transmission/reception unit 10 is configured to include an antenna unit 11, a radio frequency (RF) unit 12, and a baseband unit 13. The higher layer processing unit 14 is configured to include a control unit 15 and a radio resource control unit 16. The radio transmission/reception unit 10 is also referred to as a transmission unit or a reception unit.

The higher layer processing unit 14 outputs uplink data (transport block) generated by a user operation or the like, to the radio transmission/reception unit 10. The higher layer processing unit 14 performs processing of the medium access control (MAC) layer, a packet data convergence protocol (PDCP) layer, a radio link control (RLC) layer, and the radio resource control (RRC) layer.

The radio resource control unit 16 included in the higher layer processing unit 14 manages various configuration information/parameters of the terminal device 1 itself. The radio resource control unit 16 sets the various configuration information/parameters in accordance with a higher layer signaling received from the base station device 3. Specifically, the radio resource control unit 16 sets the various configuration information/parameters in accordance with the information indicating the various configuration information/parameters received from the base station device 3.

The radio transmission/reception unit 10 performs processing of the physical layer, such as modulation, demodulation, coding, and decoding. The radio transmission/reception unit 10 demultiplexes, demodulates, and decodes a signal received from the base station device 3, and outputs the information resulting from the decoding to the higher layer processing unit 14. The radio transmission/reception unit 10 modulates and codes data to generate a transmit signal, and transmits the transmit signal to the base station device 3.

The RF unit 12 converts (down-converts) a signal received through the antenna unit 11 into a baseband signal by orthogonal demodulation and removes unnecessary frequency components. The RF unit 12 outputs the processed analog signal to the baseband unit.

The baseband unit 13 converts the analog signal input from the RF unit 12 into a digital signal. The baseband unit 13 removes a portion corresponding to a cyclic prefix (CP) from the digital signal resulting from the conversion, performs fast Fourier transform (FFT) on the signal from which the CP has been removed, and extracts a signal in the frequency domain.

The baseband unit 13 performs inverse fast Fourier transform (IFFT) on data, generates an SC-FDMA symbol, attaches a CP to the generated SC-FDMA symbol, generates a baseband digital signal, and converts the baseband digital signal into an analog signal. The baseband unit 13 outputs the analog signal resulting from the conversion, to the RF unit 12.

The RF unit 12 removes unnecessary frequency components from the analog signal input from the baseband unit 13 using a low-pass filter, up-converts the analog signal into a signal of a carrier frequency, and transmits the final result via the antenna unit 11.

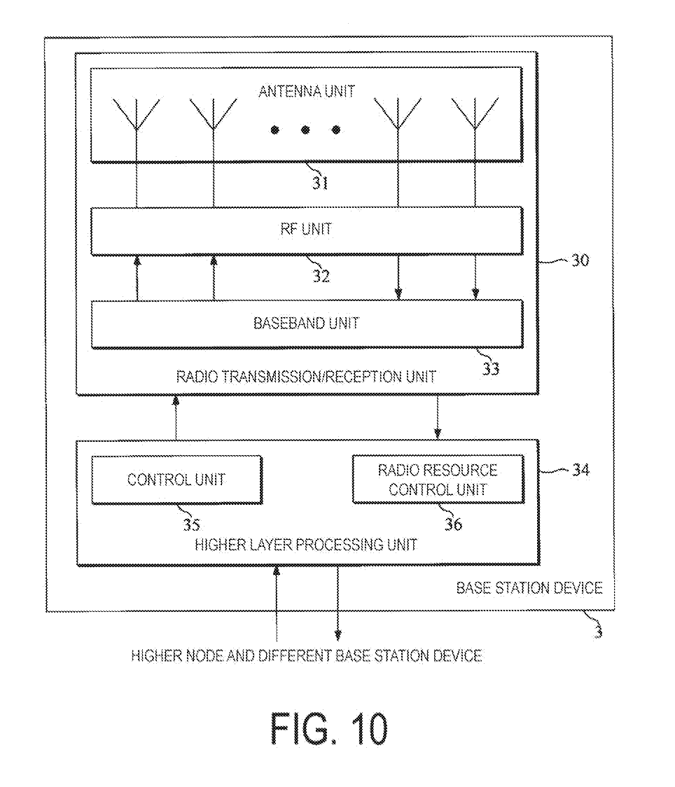

FIG. 10 is a schematic block diagram illustrating a configuration of the base station device 3 according to the present embodiment. As illustrated in FIG. 10, the base station device 3 is configured to include a radio transmission/reception unit 30 and a higher layer processing unit 34. The radio transmission/reception unit 30 is configured to include an antenna unit 31, an RF unit 32, and a baseband unit 33. The higher layer processing unit 34 is configured to include a control unit 35 and a radio resource control unit 36. The radio transmission/reception unit 30 is also referred to as a transmission unit or a reception unit.

The higher layer processing unit 34 performs processing of the medium access control (MAC) layer, the packet data convergence protocol (PDCP) layer, the radio link control (RLC) layer, and the radio resource control (RRC) layer.

The radio resource control unit 36 included in the higher layer processing unit 34 generates, or acquires from a higher node, downlink data (transport block) arranged on a physical downlink channel, system information, an RRC message, a MAC control element (CE), and the like, and outputs the generated or acquired data to the radio transmission/reception unit 30. Furthermore, the radio resource control unit 36 manages various configuration information/parameters for each of the terminal devices 1. The radio resource control unit 36 may set various configuration information/parameters for each of the terminal devices 1 via the higher layer signaling. In other words, the radio resource control unit 36 transmits/broadcasts information indicating various configuration information/parameters.

The functionality of the radio transmission/reception unit 30 is similar to that of the radio transmission/reception unit 10, and hence description thereof is omitted.

However, the functionality of the radio transmission/reception unit 10 varies among the terminal devices 1. For example, the band (carrier, frequency) combination to which carrier aggregation is applicable varies among the terminal devices 1. Therefore, the terminal device 1 transmits information/parameters UECapabilityInformation indicating the functionality supported by the terminal device 1 itself (also referred to as capability information, functionality information, terminal capability information, terminal functionality information) to the base station device 3.

The term “support” means that the terminal device 1 having hardware and/or software required for achieving the functionality (or the communication method) implemented therein has passed a conformity test (conformance test) specified by the 3GPP.

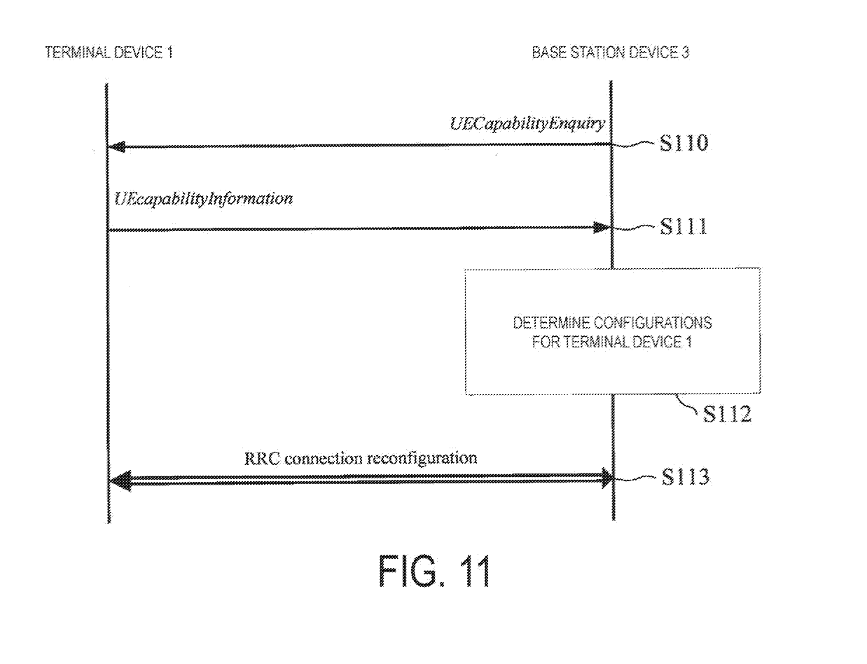

FIG. 11 is a sequence chart relating to transmission of UECapabilityInformation. UECpabilityInformation may be an RRC message.

The base station device 3 transmits, to the terminal device 1, information/parameters UECapabilityEnquitry for requesting transmission of UECapabilityInformation (S110).

The terminal device 1 that has received UECapabilityEnquitry transmits UECapabilityInformation to the base station device 3 (S111). In accordance with the received UECapabilityInformation, the base station device 3 determines the configuration for the terminal device 1 (S112). In accordance with the determined configuration, the base station device 3 performs RRC connection reconfiguration for the terminal device 1 (S113).

These processes allow the base station device 3 to configure cells in the cellular link on the basis of the functionality supported by the terminal device 1.

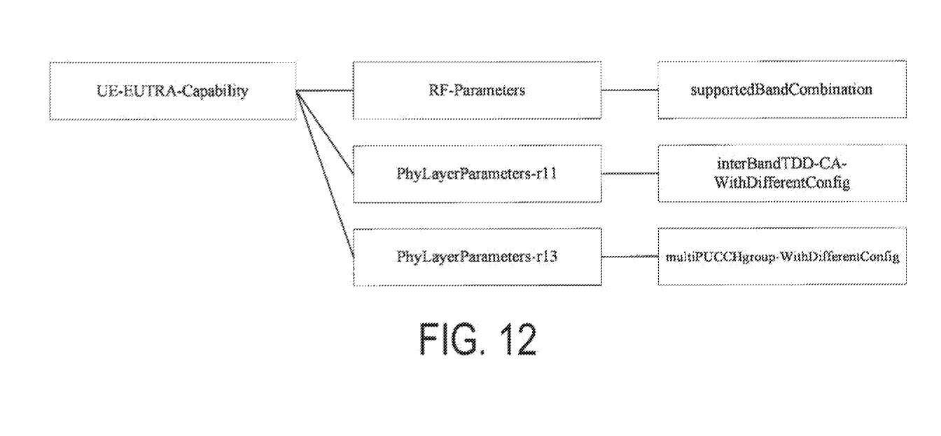

FIG. 12 illustrates a part of a constitution of information/parameters UE-EUTRA-Capability included in UECapabilityInformation according to the present embodiment.

UE-EUTRA-Capability includes information/parameters RF-Parameters, information/parameters PhyLayerParameters-r11 and PhyLayerParameters-r13. However, RF-Parameters, PhyLayerParameters-r11, and PhyLayerParameters-r13 may be included in any information in UE-EUTRA-Capability. For example, PhyLayerParameters-r11 may be included in information/parameters UE-EUTRA-Capability-r11 included in UE-EUTRA-Capability, and PhyLayerParameters-r13 may be included in information/parameters UE-EUTRA-Capability-r13 included in UE-EUTRA-Capability-r11.

RF-Parameters includes information/parameters SupportedBandCombination indicating the band combination to which carrier aggregation is applicable. Hereinafter, the band to which carrier aggregation is applicable is also referred to as a CA band. A band to which carrier aggregation is not applicable or a band to which carrier aggregation is applicable but is not applied is also referred to as a non-CA band.

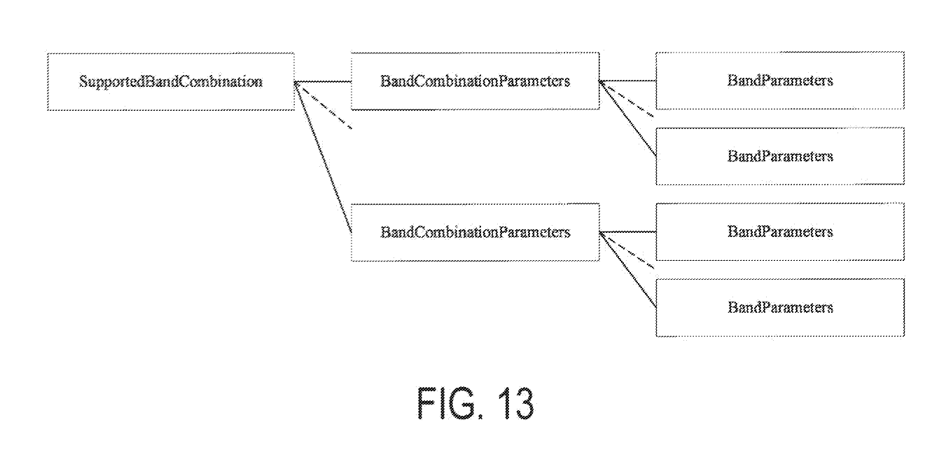

FIG. 13 is a diagram illustrating information/parameters included in SupportedBandCombination according to the present embodiment.

SupportedBandCombination includes one or multiple BandCombinationParameters. SupportedBandCombination includes a supported CA band combination and a supported non-CA band.

BandCombinationParameters includes one or multiple BandParameters. Each BandCombinationParameters indicates a supported CA band combination or a supported non-CA band. For example, when BandCombinationParameters includes multiple BandParameters, communication to which carrier aggregation with the combination of CA bands indicated by the multiple BandParameters is applied is supported. When BandCombinationParameters includes one BandParameters, communication in the band (non-CA band) indicated by the one BandParameters is supported.

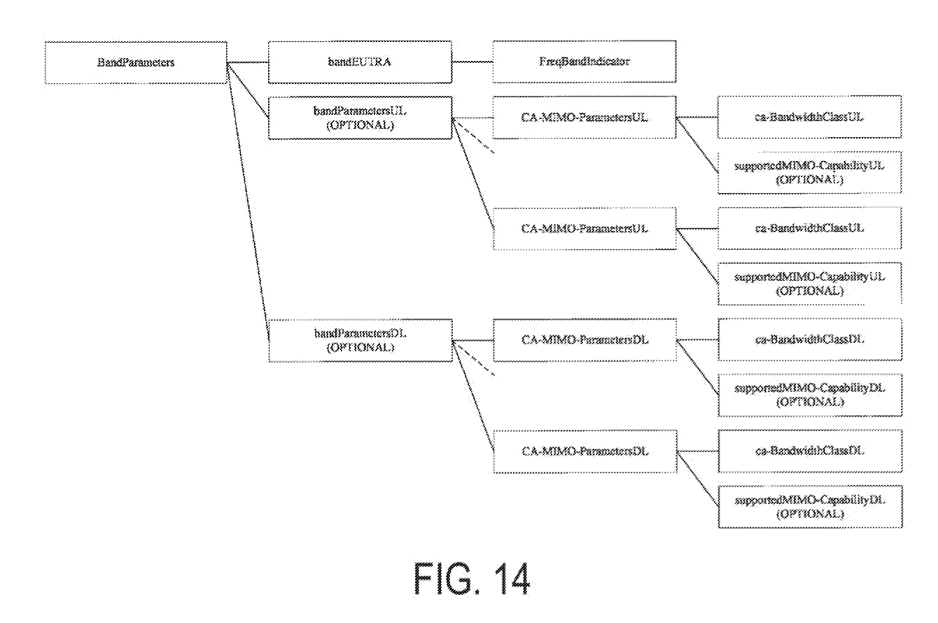

FIG. 14 is a diagram illustrating information/parameters included in BandParameters according to the present embodiment. BandParameters includes bandEUTRA, bandParametersUL, and bandParametersDL.

bandEUTRA includes FreqBandIndicator. FreqBandlndicator indicates a band. When the terminal device 1 is not capable of transmitting an uplink signal in the band indicated by FreqBandIndicator, BandParameters does not include bandParametersUL. When the terminal device 1 is not capable of receiving a downlink signal in the band indicated by FreqBandlndicator, BandParameters does not include bandParametersDL.

bandParametersUL includes one or multiple CA-MIMO-ParametersUL. CA-MIMO-ParametersUL includes ca-BandwidthClassUL and supportedMIMO-CapabilityUL. ca-BandwidthClassU L includes CA-BandwidthClass.

supportedMIMO-CapabilityUL indicates the number of layers supported for spatial multiplexing in the uplink. When spatial multiplexing is not supported in the uplink, CA-MIMO-ParametersUL does not include supportedMIMO-CapabilityUL.

bandParametersDL includes one or multiple CA-MIMO-ParametersDL. CA-MIMO-ParametersDL includes ca-BandwidthClassDL and supportedMIMO-CapabilityDL. ca-BandwidthClassDL includes CA-BandwidthClass.

supportedMIMO-CapabilityDL indicates the number of layers supported for spatial multiplexing in the downlink. When spatial multiplexing is not supported in the downlink, CA-MIMO-ParametersDL does not include supportedMIMO-CapabilityUL.

CA-BandwidthClass indicates the CA bandwidth class supported by the terminal device 1 in the uplink or the downlink. CA-BandwidthClassUL corresponds to the CA bandwidth class supported by the terminal device 1 in the uplink. CA-BandwidthClassDL corresponds to the CA bandwidth class supported by the terminal device 1 in the downlink. Each of the CA bandwidth classes is defined by the number of cells that can be simultaneously configured by the terminal device 1 in the band indicated by FreqBandlndicator, the total of the bandwidths of the cells simultaneously configured in the band indicated by FreqBandlndicator, and the like. For example, a CA bandwidth class a indicates that a single cell of 20 MHz or lower is configurable.

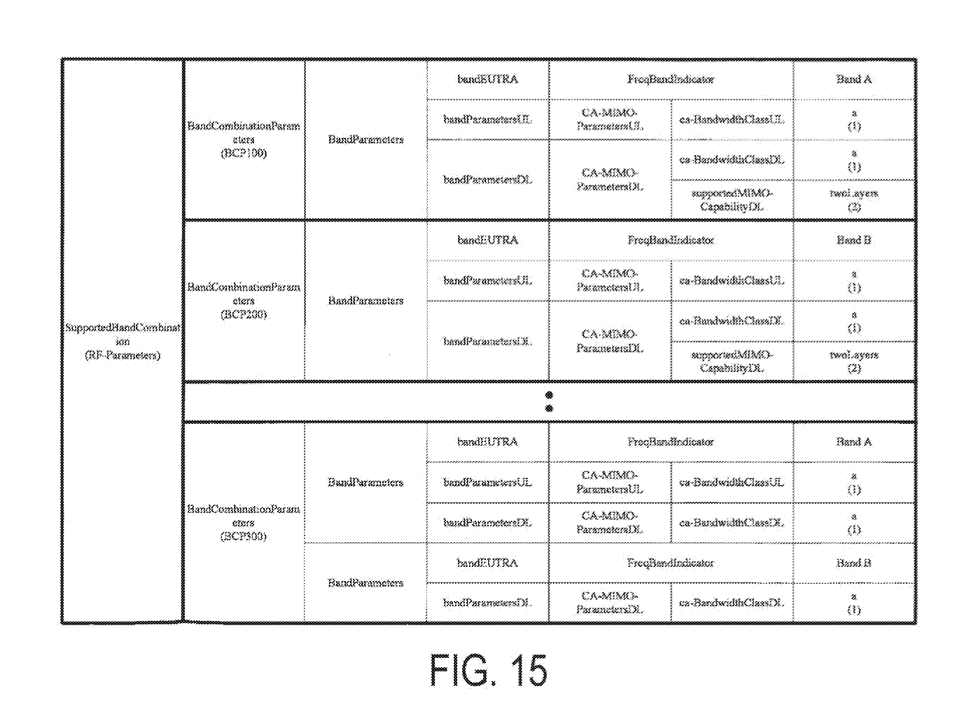

FIG. 15 is a diagram illustrating one example of RF-Parameters according to the present embodiment. For example, RF-Parameters includes one SupportedBandCombination. As described above, SupportedBandCombination includes one or multiple BandCombinationParameters.

BandCombinationParameters includes one or multiple BandParameters. BandCombinationParameters of BCP100 indicates that uplink transmission is possible on a single cell in Band A and that downlink transmission is possible on a single cell in Band A. In other words, BandCombinationParameters of BCP100 indicates that a single cell is supported in Band A.

BandCombinationParameters of BCP100 indicates that two layers are supported for spatial multiplexing in the downlink in Band A.
BandCombinationParameters of BCP100 indicates that spatial multiplexing is not supported in the uplink in Band A.

BandCombinationParameters of BCP300 indicates that uplink transmission is possible on a single cell in Band A, that downlink transmission is possible on a single cell in Band A, and that downlink transmission is possible on a single cell in Band B. In other words, BandCombinationParameters of BCP100 indicates that a combination of a single primary cell in Band A and a single secondary cell in Band B without uplink. BandCombinationParameters of BCP300 indicates that none of the spatial multiplexing in the downlink in Band A, the spatial multiplexing in the downlink in Band B, and the spatial multiplexing in the uplink in Band A is supported.

When the terminal device 1 supports TDD carrier aggregation between bands (e.g., when SupportedBandCombination includes BandCombinationParameters supporting a combination of multiple bands using the TDD scheme), PhyLayerParameters-r11 may include information/parameters interBandTDD-CA-WithDifferentConfig.

interBandTDD-CA-WithDifferentConfig indicates whether or not the terminal device 1 supports inter-band TDD carrier aggregation using different UL-DL configuration combinations.

However, interBandTDD-CA-WithDifferentConfig may apply to multiple serving cells in the same cell group. In other words, interBandTDD-CA-WithDifferentConfig may indicate whether or not the terminal device 1 supports the inter-band TDD carrier aggregation using the UL-DL configuration combinations different between a serving cell in a first band and a serving cell in a second band, both the serving cells being included in the same cell group.

interBandTDD-CA-WithDifferentConfig is represented by two bits. The first bit indicates whether or not the terminal device 1 supports a UL-DL configuration combination where the downlink subframes on the secondary cell correspond to a subset of the downlink subframes on the primary cell, and a UL-DL configuration where the downlink subframes on the secondary cell correspond to a superset of the downlink subframes on the primary cell. The second bit indicates whether or not the terminal device 1 supports a UL-DL configuration combination where the downlink subframes on the secondary cell do not correspond to a subset nor superset of the downlink subframes on the primary cell. For example, when a UL-DL configuration on primary cell is the UL-DL configuration 2 illustrated in FIG. 8, a UL-DL configuration where the downlink subframes on the secondary cell correspond to a subset of the downlink subframes on the primary cell is the UL-DL configurations 0, 1, or 6 illustrated in FIG. 8, a UL-DL configuration where the downlink subframes on the secondary cell correspond to a superset of the downlink subframes on the primary cell is the UL-DL configuration 5 illustrated in FIG. 8, and a UL-DL configuration where the downlink subframes on the secondary cell do not correspond to a subset nor superset of the downlink subframes on the primary cell is the UL-DL configurations 3 or 4 illustrated in FIG. 8.

When the terminal device 1 supports the TDD carrier aggregation between bands and supports that two or more PUCCH serving cells are aggregated, PhyLayerParameters-r13 may include information/parameters multiPUCCHgroup-WithDifferentConfig. However, multiPUCCHgroup-WithDifferentConfig may be included in PhyLayerParameters-r13 only when the terminal device 1 supports the TDD carrier aggregation between bands and supports that two or more PUCCH serving cells are aggregated across two or more different bands. However, multiPUCCHgroup-WithDifferentConfig may be included in PhyLayerParameters-r13 when the terminal device 1 supports the TDD carrier aggregation between bands and supports that two or more PUCCH cell groups are aggregated.

Information/parameters multiPUCCHgroup-WithDifferentConfig indicates whether or not the terminal device 1 supports the TDD carrier aggregation of multiple PUCCH cell groups having different UL-DL configuration combinations. However, the same UL-DL configuration is configured for serving cells in the same band; thus, configuration of different UL-DL configurations is not supported for the serving cells in the same band regardless of the value of multiPUCCHgroup-WithDifferentConfig.

multiPUCCHgroup-WithDifferentConfig may be transmitted as one-bit information. When this bit is 1, this indicates that the terminal device 1 supports the TDD carrier aggregation of PUCCH cell groups having different UL-DL configurations.

However, multiPUCCHgroup-WithDifferentConfig may be information/parameters indicating that even the terminal device 1 not supporting the inter-band TDD carrier aggregation using the different UL-DL configuration combinations indicated by interBandTDD-CA-WithDifferentConfig supports the inter-band TDD carrier aggregation using the UL-DL configuration combinations different between the different PUCCH cell groups.

Note that, in the present embodiment, description is given on the basis of the assumption that multiPUCCHgroup-WithDifferentConfig has one-bit length, but multiPUCCHgroup-WithDifferentConfig may be transmitted as multiple-bit information. For example, when multiPUCCHgroup-WithDifferentConfig is transmitted in two-bit length, the first bit of multiPUCCHgroup-WithDifferentConfig may indicate whether or not the terminal device 1 supports a UL-DL configuration combination where the downlink subframes on each serving cell belonging to the second PUCCH cell group correspond to a subset of the downlink subframes on each serving cell belonging to the first PUCCH cell group, and a UL-DL configuration combination where the downlink subframes on each serving cell belonging to the second PUCCH cell group correspond to a superset of the downlink subframes on each serving cell belonging to the first PUCCH cell group. The second bit of multiPUCCHgroup-WithDifferentConfig may indicate whether or not the terminal device 1 supports a UL-DL configuration combination where the downlink subframes on each serving cell belonging to the second PUCCH cell group do not correspond to a subset nor superset of the downlink subframes on each serving cell belonging to the first PUCCH cell group.

When both of the two bits indicating interBandTDD-CA-WithDifferentConfig are 1, configuration of UL-DL configurations different between serving cells in different bands is supported, which ensures that multiPUCCHgroup-WithDifferentConfig is 1. Therefore, in this case, the terminal device 1 may not transmit multiPUCCHgroup-WithDifferentConfig. Alternatively, the terminal device 1 may transmit multiPUCCHgroup-WithDifferentConfig, and when both of the two bits of interBandTDD-CA-WithDifferentConfig are 1, the base station device 3 that has received the terminal capability information where multiPUCCHgroup-WithDifferentConfig is 0 may determine that these bits have an error and then perform exception handling (for example, the base station device 3 may request the terminal device 1 to retransmit that terminal capability information).

When either of the two bits indicating interBandTDD-CA-WithDifferentConfig is 1 and multiPUCCHgroup-WithDifferentConfig is 0, the terminal device 1 supports a UL-DL configuration combination between the serving cells in different bands depending on the value of the bits included in interBandTDD-CA-WithDifferentConfig regardless of the PUCCH cell group.

When any one of the two bits indicating interBandTDD-CA-WithDifferentConfig is 1 and multiPUCCHgroup-WithDifferentConfig is 1, the terminal device 1 supports different UL-DL configurations for the serving cells in different PUCCH cell groups, and supports a UL-DL configuration combination depending on a value of the bits included in interBandTDD-CA-WithDifferentConfig for the serving cells in the different bands in the same PUCCH cell group.

When both of the two bits indicting interBandTDD-CA-WithDifferentConfig are 0 and multiPUCCHgroup-WithDifferentConfig is 0, the terminal device 1 does not support configuration of UL-DL configurations different between the serving cells in the different bands and between the serving cells in the different PUCCH cell groups. However, when multiple bands are included in the same PUCCH cell group, the same UL-DL configuration is configured in this PUCCH cell group.

When both of the two bits indicating interBandTDD-CA-WithDifferentConfig are 0 and multiPUCCHgroup-WithDifferentConfig is 1, the terminal device 1 supports configuration of UL-DL configurations different for each of the serving cells in the different bands in the different PUCCH cell groups, and does not support configuration of UL-DL configurations different between the serving cells in the different bands in the same PUCCH cell group.

However, when multiple bands are included in the same PUCCH cell group, the same UL-DL configuration may be configured in this PUCCH cell group.

Note that multiPUCCHgroup-WithDifferentConfig is described above as the configuration/parameters which is transmitted in one-bit length to be one configuration for the terminal device 1, but may be configured for each supported band or each combination of supported bands, for example.

Note that UECapabilityInformation described above may further indicate functionality which is not indicated by the above-described information/parameters and which the terminal device 1 supports or does not support. UECapabilityInformation described above may include information/parameters other than the above-described information/parameters.

For example, UECapabilityInformation may indicate whether or not the terminal device 1 supports the PUCCH transmission on a serving cell (PUCCH secondary cell) other than the primary cell.

UECapabilityInformation may include information/parameters indicating whether or not the terminal device 1 supports the PUCCH transmission on a serving cell (PUCCH secondary cell) other than the primary cell.

UECapabilityInformation may indicate whether or not the terminal device 1 supports simultaneous multiple PUCCH transmissions on different serving cells (multiple serving cells).

UECapabilityInformation may include information indicating whether or not the terminal device 1 supports simultaneous multiple PUCCH transmissions on different serving cells (multiple serving cells).

UECapabilityInformation may indicate how many simultaneous PUCCH transmissions on different serving cells (multiple serving cells) the terminal device 1 supports.

UECapabilityInformation may include information indicating how many simultaneous PUCCH transmissions on different serving cells (multiple serving cells) the terminal device 1 supports.

UECapabilityInformation may indicate whether or not the terminal device 1 supports simultaneous PUCCH and PUSCH transmissions.

UECapabilityInformation may include information indicating whether or not the terminal device 1 supports simultaneous PUCCH and PUSCH transmissions.

UECapabilityInformation may indicate whether or not the terminal device 1 supports multi-cluster PUSCH transmission on one serving cell (component carrier).

UECapabilityInformation may include information indicating whether or not the terminal device 1 supports multi-cluster PUSCH transmission on one serving cell (component carrier).

Note that the information/parameters included in UECapabilityInformation described above may individually apply to each band supported by the terminal device 1. In other words, the information/parameters included in UECapabilityInformation described above may be information different for each band supported by the terminal device 1.

The information/parameters included in UECapabilityInformation described above may individually apply to each combination of bands supported by the terminal device 1 (e.g., each combination of bands indicated by BandCombinationParameters). In other words, the information/parameters included in UECapabilityInformation described above may be information different for each combination of bands supported by the terminal device 1 (e.g., each combination of bands indicated by BandCombinationParameters).

Note that the information/parameters included in UECapabilityInformation described above may apply in common to the bands or combination of bands supported by the terminal device 1 (band agnostic). In other words, the information/parameters included in UECapabilityInformation described above may be common information for the bands or combination of bands supported by the terminal device 1 (band agnostic).

On the basis of the above description, the terminal device 1 according to the present embodiment may have the following features.

The terminal device 1 according to the present embodiment is the terminal device 1 communicating with the base station device 3. The terminal device 1 includes a transmission unit configured to: transmit an HARQ-ACK with respect to a physical downlink shared channel (PUSCH) on multiple serving cells included in a first cell group (also referred to as a first PUCCH cell group) to the base station device 3 by using a physical uplink control channel (PUCCH) on a first serving cell included in the first cell group; transmit an HARQ-ACK with respect to a physical downlink shared channel on multiple serving cells included in a second cell group (also referred to as a second PUCCH cell group) to the base station device 3 by using a physical uplink control channel on a second serving cell included in the second cell group; and transmit, to the base station device 3, UECapabilityInformation (here, referred to as capability information) including interBandTDD-CA-WithDifferentConfig (here, referred to as first information) indicating whether or not the terminal device 1 supports inter-band TDD carrier aggregation (also referred to as inter-band TDD CA) using UL-DL configuration combinations different between a serving cell in a first band included in the first cell group and a serving cell in a second band included in the first cell group, and multiPUCCHgroup-WithDifferentConfig (here, referred to as second information) indicating whether or not the terminal device 1 supports TDD carrier aggregation between cell groups (also referred to as inter-PUCCHgroup TDD CA) using UL-DL configuration combinations different between the serving cell in the first band included in the first cell group and a serving cell included in the second cell group.

In the terminal device 1 according to the present embodiment, the serving cell included in the second cell group may be a serving cell in a band different from the first band.

The base station device 3 according to the present embodiment may have the following features.

The base station device 3 according to the present embodiment is the base station device 3 communicating with the terminal device 1. The base station device 3 includes a reception unit configured to: receive an HARQ-ACK with respect to a physical downlink shared channel on multiple serving cells included in a first cell group from the terminal device by using a physical uplink control channel on a first serving cell included in the first cell group; receive an HARQ-ACK with respect to a physical downlink shared channel on multiple serving cells included in a second cell group from the terminal device by using a physical uplink control channel on a second serving cell included in the second cell group; and receive, from the terminal device, capability information including first information indicating whether or not the terminal device supports inter-band TDD carrier aggregation using UL-DL configuration combinations different between a serving cell in a first band included in the first cell group and a serving cell in a second band included in the first cell group, and second information indicating whether or not the terminal device supports TDD carrier aggregation between cell groups using UL-DL configuration combinations different between the serving cell in the first band included in the first cell group and a serving cell included in the second cell group.

In the base station device 3 according to the present embodiment, the serving cell included in the second cell group may be a serving cell in a band different from the first band.

A program running on each of the base station device 3 and the terminal device 1 according to the present invention may be a program that controls a central processing unit (CPU) and the like (a program for causing a computer to operate) in such a manner as to realize the functions according to the above-described embodiments of the present invention. The information handled in these devices is temporarily stored in a random access memory (RAM) while being processed. Thereafter, the information is stored in various types of read only memory (ROM) such as a flash ROM and a hard disk drive (HDD) and when necessary, is read by the CPU to be modified or rewritten.

Moreover, the terminal device 1 and the base station device 3 according to the above-described embodiments may be partially realized by the computer. This configuration may be realized by recording a program for realizing such control functions on a computer-readable medium and causing a computer system to read the program recorded on the recording medium for execution.

Moreover, the “computer system” here is defined as a computer system built into the terminal device 1 or the base station device 3, and the computer system includes an OS and hardware components such as a peripheral device. Furthermore, the “computer-readable recording medium” refers to a portable medium such as a flexible disk, a magneto-optical disk, a ROM, and a CD-ROM, and a storage device such as a hard disk built into the computer system.

Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client. Furthermore, the above-described program may be configured to realize some of the functions described above, and additionally may be configured to be capable of realizing the functions described above in combination with a program already recorded in the computer system.

Furthermore, the base station device 3 according to the above-described embodiments can be realized as an aggregation (a device group) constituted of multiple devices. Devices constituting the device group may be each equipped with some or all portions of each function or each functional block of the base station device 3 according to the above-described embodiments. It is only required that the device group itself include general functions or general functional blocks of the base station device 3. Furthermore, the terminal device 1 according to the above-described embodiments can also communicate with the base station device as the aggregation.

Furthermore, the base station device 3 according to the above-described embodiments may be an Evolved Universal Terrestrial Radio Access Network (EUTRAN). Furthermore, the base station device 3 according to the above-described embodiments may have some or all portions of the function of a node higher than an eNodeB.

Furthermore, some or all portions of each of the terminal device 1 and the base station device 3 according to the above-described embodiments may be realized as an LSI that is a typical integrated circuit or may be realized as a chip set. The functional blocks of each of the terminal device 1 and the base station device 3 may be individually realized as a chip, or some or all of the functional blocks may be integrated into a chip. Furthermore, a circuit integration technique is not limited to the LSI, and the integrated circuit may be realized with a dedicated circuit or a general-purpose processor. Furthermore, if with advances in semiconductor technology, a circuit integration technology with which an LSI is replaced appears, it is also possible to use an integrated circuit based on the technology.

Furthermore, according to the above-described embodiments, the terminal device is described as one example of a communication device, but the present invention is not limited to this, and can be applied to a fixed-type electronic apparatus installed indoors or outdoors, or a stationary-type electronic apparatus, for example, a terminal device or a communication device, such as an audio-video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which a constituent element that achieves the same effect is substituted for the one that is described according to the embodiments is also included in the technical scope of the present invention.

### INDUSTRIAL APPLICABILITY

Some aspects of the present invention can be applied to a terminal device, a base station device, an integrated circuit, and a communication method which are necessary to perform efficient communication using multiple cells (component carriers).

### DESCRIPTION OF REFERENCE NUMERALS

1 (1A, 1B, IC) Terminal device
3 Base station device
10 Radio transmission/reception unit
11 Antenna unit
12 RF unit
13 Baseband unit
14 Higher layer processing unit
15 Control unit
16 Radio resource control unit
30 Radio transmission/reception unit
31 Antenna unit
32 RF unit
33 Baseband unit
34 Higher layer processing unit
35 Control unit
36 Radio resource control unit

1. A terminal device communicating with a base station device, comprising a transmission unit configured to:
transmit an HARQ-ACK with respect to a physical downlink shared channel on multiple serving cells included in a first cell group to the base station device by using a physical uplink control channel on a first serving cell included in the first cell group;
transmit an HARQ-ACK with respect to a physical downlink shared channel on multiple serving cells included in a second cell group to the base station device by using a physical uplink control channel on a second serving cell included in the second cell group; and
transmit, to the base station device, capability information including:
first information indicating whether or not the terminal device supports inter-band TDD carrier aggregation using UL-DL configuration combinations different between a serving cell in a first band included in the first cell group and a serving cell in a second band included in the first cell group, and
second information indicating whether or not the terminal device supports TDD carrier aggregation between cell groups using UL-DL configuration combinations different between the serving cell in the first band included in the first cell group and a serving cell included in the second cell group.

2. The terminal device according to claim 1, wherein the serving cell included in the second cell group is a serving cell in a band different from the first band.

3. A base station device communicating with a terminal device, comprising a reception unit configured to:
receive an HARQ-ACK with respect to a physical downlink shared channel on multiple serving cells included in a first cell group from the terminal device by using a physical uplink control channel on a first serving cell included in the first cell group;
receive an HARQ-ACK with respect to a physical downlink shared channel on multiple serving cells included in a second cell group from the terminal device by using a physical uplink control channel on a second serving cell included in the second cell group; and
receive, from the terminal device, capability information including:
first information indicating whether or not the terminal device supports inter-band TDD carrier aggregation using UL-DL configuration combinations different between a serving cell in a first band included in the first cell group and a serving cell in a second band included in the first cell group, and
second information indicating whether or not the terminal device supports TDD carrier aggregation between cell groups using UL-DL configuration combinations different between the serving cell in the first band included in the first cell group and a serving cell included in the second cell group.

4. The base station device according to claim 3, wherein the serving cell included in the second cell group is a serving cell in a band different from the first band.

5. An integrated circuit mounted on a terminal device communicating with a base station device, the integrated circuit causing the terminal device to exert a series of functions of:
transmitting an HARQ-ACK with respect to a physical downlink shared channel on multiple serving cells included in a first cell group to the base station device by using a physical uplink control channel on a first serving cell included in the first cell group;
transmitting an HARQ-ACK with respect to a physical downlink shared channel on multiple serving cells included in a second cell group to the base station device by using a physical uplink control channel on a second serving cell included in the second cell group; and
transmitting, to the base station device, capability information including:
first information indicating whether or not the terminal device supports inter-band TDD carrier aggregation using UL-DL configuration combinations different between a serving cell in a first band included in the first cell group and a serving cell in a second band included in the first cell group, and
second information indicating whether or not the terminal device supports TDD carrier aggregation between cell groups using UL-DL configuration combinations different between the serving cell in the first band included in the first cell group and a serving cell included in the second cell group.

6. The integrated circuit according to claim 5, wherein the serving cell included in the second cell group is a serving cell in a band different from the first band.

7. An integrated circuit mounted on a base station device communicating with a terminal device, the integrated circuit causing the base station device to exert a series of functions of:
receiving an HARQ-ACK with respect to a physical downlink shared channel on multiple serving cells included in a first cell group from the terminal device by using a physical uplink control channel on a first serving cell included in the first cell group;
receiving an HARQ-ACK with respect to a physical downlink shared channel on multiple serving cells included in a second cell group from the terminal device by using a physical uplink control channel on a second serving cell included in the second cell group; and
receiving, from the terminal device, capability information including:
first information indicating whether or not the terminal device supports inter-band TDD carrier aggregation using UL-DL configuration combinations different between a serving cell in a first band included in the first cell group and a serving cell in a second band included in the first cell group, and
second information indicating whether or not the terminal device supports TDD carrier aggregation between cell groups using UL-DL configuration combinations different between the serving cell in the first band included in the first cell group and a serving cell included in the second cell group.

8. The integrated circuit according to claim 7, wherein the serving cell included in the second cell group is a serving cell in a band different from the first band.

9. A communication method used by a terminal device communicating with a base station device, the communication method comprising the steps of:
transmitting an HARQ-ACK with respect to a physical downlink shared channel on multiple serving cells included in a first cell group to the base station device by using a physical uplink control channel on a first serving cell included in the first cell group;
transmitting an HARQ-ACK with respect to a physical downlink shared channel on multiple serving cells included in a second cell group to the base station device by using a physical uplink control channel on a second serving cell included in the second cell group; and
transmitting, to the base station device, capability information including:
first information indicating whether or not the terminal device supports inter-band TDD carrier aggregation using UL-DL configuration combinations different between a serving cell in a first band included in the first cell group and a serving cell in a second band included in the first cell group, and
second information indicating whether or not the terminal device supports TDD carrier aggregation between cell groups using UL-DL configuration combinations different between the serving cell in the first band included in the first cell group and a serving cell included in the second cell group.

10. The communication method according to claim 9, wherein the serving cell included in the second cell group is a serving cell in a band different from the first band.

11. A communication method used by a base station device communicating with a terminal device, the communication method comprising the steps of:
receiving an HARQ-ACK with respect to a physical downlink shared channel on multiple serving cells included in a first cell group from the terminal device by using a physical uplink control channel on a first serving cell included in the first cell group;
receiving an HARQ-ACK with respect to a physical downlink shared channel on multiple serving cells included in a second cell group from the terminal device by using a physical uplink control channel on a second serving cell included in the second cell group; and
receiving, from the terminal device, capability information including:
first information indicating whether or not the terminal device supports inter-band TDD carrier aggregation using UL-DL configuration combinations different between a serving cell in a first band included in the first cell group and a serving cell in a second band included in the first cell group, and
second information indicating whether or not the terminal device supports TDD carrier aggregation between cell groups using UL-DL configuration combinations different between the serving cell in the first band included in the first cell group and a serving cell included in the second cell group.

12. The communication method according to claim 11, wherein the serving cell included in the second cell group is a serving cell in a band different from the first band.
